(19) United States
(12) Patent Application Publication
(10) Pub. No.: US 2006/0198509 A1
(43) Pub. Date: Sep. 7, 2006

(54) Method and system of call screening

(75) Inventors: Anup D. Karnalkar, Allen, TX (US); Thomas A. Hendricks, Oaks, CA (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 11/071,338

(22) Filed: Mar. 3, 2005

(51) Int. Cl. H04M 7/00

(52) U.S. Cl. 379/239

(57) ABSTRACT

Method and system of call screening. The method and system including screening of calls according to call screening instructions. The call screening instructions may include instructions for performing any number of call screening operations, including instructions associated with allowing or blocking international telephone calls.

### BACKGROUND OF THE INVENTION

1. Field of the Invention

The present invention relates to methods and system of call screening.

2. Background Art

The screening of telephone calls permits providers and customers to allow or block calls. In this manner, the providers may prevent fraud on their customers and the customers, such as businesses, may prevent users from accruing excessive fees. The ability to allow and block calls is done at a nature of address (NOA) level where calls are blocked as a function of what type of call it is as opposed to where the call is originating from or directed to.

### BRIEF DESCRIPTION OF THE DRAWINGS

FIG. 1 illustrates a system in accordance with one non-limiting aspect of the present invention.

### DETAILED DESCRIPTION OF THE PREFERRED EMBODIMENT(S)

One aspect of the present invention relates to screening telephone calls at a granular level. In accordance with one non-limiting aspect of the present invention the calls are screened as a function of specific digits associated therewith, such as a function of digits associated with country codes, country codes plus city codes, and/or complete numbers.

One aspect of the present invention relates to a system of screening international calls. The system may include a service contact point (SCP) configured to apply at least one of a number of granular call screening features to international calls so as to screen the international calls according to subscriber specified call screening instructions.

In accordance with one non-limiting aspect of the present invention, the call screening features may include at least one of an international origination serving area routing (IOSAR) feature, international destination serving area routing (IDSAR) feature, international originating dependent routing (IODR) feature, or international destination dependent routing (IDDR) feature.

In accordance with one non-limiting aspect of the present invention, the SCP may be configured to receive queries from call routing features upon receipt of international calling requests and response thereto with instructions as to whether the requested call should be blocked or allowed.

In accordance with one non-limiting aspect of the present invention, the SCP may be configured to receive non-digit specific call screening instructions and to associate the non-digit specific instructions with digit specific instructions to facilitate screening of the international telephone calls.

In accordance with one non-limiting aspect of the present invention, the system may include a database of telephone numbers associated with non-digit specific identifiers for use in associating the non-digit specific call screening instructions with digit specific call screening instructions.

One non-limiting aspect of the present invention relates to a method of screening international calls. The method generally includes receiving call screening instructions from a subscriber, receiving an international call, determining whether the international call is associated with the subscriber, if the international call is associated with the subscriber, determining a screening feature for the international call as a function of the call screening instructions, and routing the international call as a function of the screening feature.

One non-limiting aspect of the present invention relates to a method of call screening. The method generally includes determining digit specific call screening instructions as a function of non-digit specific call screening instructions specified by the subscriber, determining at least one call screening feature as a function of the non-digit specific call screening instructions specified by the subscriber, and screening the telephone call as a function of the digit specific call screening instructions and the call screening features.

The above features and advantages, along with other features and advantages of the present invention, are readily apparent from the following detailed description of the invention when taken in connection with the accompanying drawings.

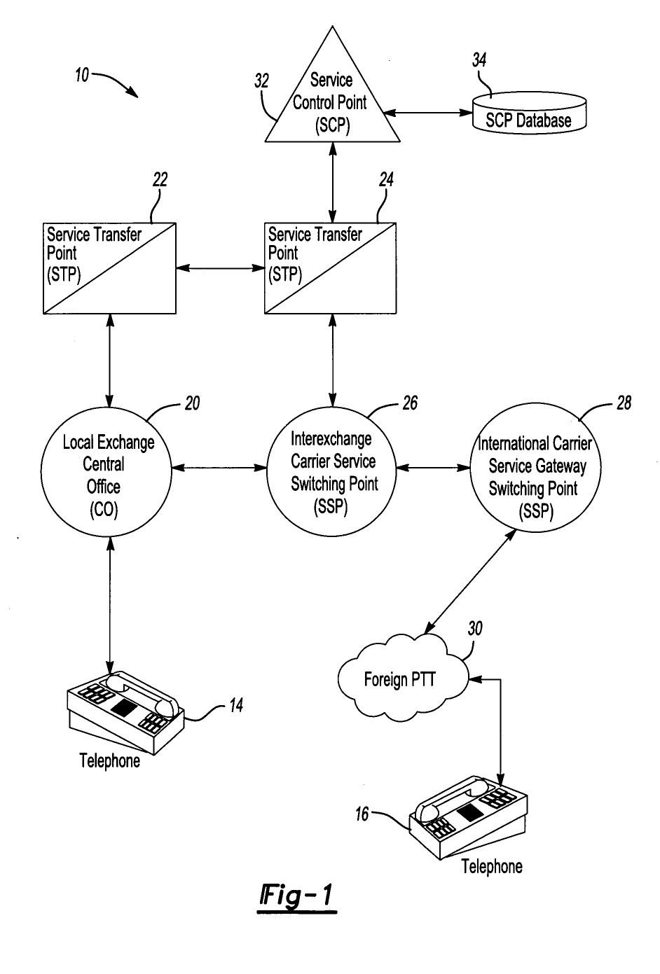

FIG. 1 illustrates a system 10 in accordance with one non-limiting aspect of the present invention. The system 10 generally corresponds with a telecommunication system configured to support international call between multiple countries, such as between the United States and other countries.

The system may include any number of features, exchanges, switches, networks and other parameters to facilitation international call between a national telephone 14 and an international telephone 16. In particular, the system may include a local exchange central office (CO) 20, a national service transfer point (STP) 22, an international STP 24, an interexchange carrier service switching point (SSP) 26, an international carrier SSP 28, a foreign post telegraph and telephone (PTT) network 30, a service control point (SCP) 32, and a SCP database 34.

Of course, the present invention contemplates any number of components and is not intended to be limited to the foregoing. Rather, the foregoing is intended to represent one of a number of configurations suitable for screening international phone calls. In particular, the present invention contemplates screening calls communicated through terrestrial or extraterrestrial wireless configurations, IP packet switching networks, and the like.

In operation a calling party may make an international call from either of the national or international telephones 14-16 to a called party, which for the purposes of the present invention is located in a foreign country such that the desired telephone call relates to an international telephone call. The international telephone call may be routed from the calling party to the called party through signal switching, routing, and other operations performed by the features shown in FIG. 1.

For example, if the international call originations from the national telephone 14, the local exchange CO 20 provides a dial-tone for receiving a complete telephone number. The user of the national telephone 14 then presses in, for the purposes of the present invention, an international number, which typically includes a international direct dial destination indicator (i.e., 011), a country code, a city code, and a specific number, which combine to define the complete telephone number associated with the recipient.

The local exchange CO 20 reviews the inputted telephone number and determines the interexchange carrier associated with the subscriber of the national telephone 14, i.e. the subscriber's long-distance carrier. Once the interexchange carrier SSP 26 is determined, the local exchange CO 20 routes the call thereto for further processing. In addition, the local exchange carrier CO 20 communicates out-of-band signals related thereto, such as call setup and the like, to the local STP 22. The local STP 22 then looks at the received information and contacts the appropriate interexchange carrier STP 24, which then sets the call up for switching according to the configuration of the interexchange carrier SSP 26.

The interexchange carrier SSP 26 then queries the SCP 32 by way of the STP 26 for information on the services associated with the subscriber. In accordance with one non-limiting aspect of the present invention, the SCP 32 is provided with subscriber information associated with the telephone from which the call is made, calling party information associated the user initiating the call, called party information associated with the recipient of the call, or other information related thereto.

In response to the receipt of such a query, the SCP 32 may review the SCP database 34 to determine whether the subscriber has implemented any call screening applications or features. As described below in more detail, the subscriber may have such features for determining whether the international call should be allowed or block. The SCP 32 instructs the interexchange carrier SSP 26 to allow or block the call based on such instructions. If the call is allowed, the interexchange SSP 26 sends the call to the foreign PTT 30 via the international gateway 28 for routing and delivery, as one skilled in the art will appreciate.

In accordance with one non-limiting aspect of the present invention, a method of screening international telephone calls is provided. The method generally relates to permitting subscribers, customers, businesses, companies, and the like to allow and/or block international telephone, such as by programming the SCP to instruct the interexchange carrier SSP or other feature in the system to allow or block international calls, and/or to perform any number of other call screening operations.

The method may operate in conjunction with the system described above or other similar systems to provide a flexible call screening system that advantageously permits users to allow or block calls at a granular level. In particular, the present invention contemplates the method being associated with a self-executing application, program, logic, or other feature suitable for allowing or blocking international calls.

One aspect of the method relates to provisioning the SCP or other system feature with call screening instructions. The call screening instructions may relate to one or more sets of instructions specified by the subscriber for association with all calls originating from the subscribers telephone, or in the case of large entities or businesses, telephones. The call screening instructions may control which calls are screened, how the calls are screened, and other operations related to call screening. In accordance with one non-limiting aspect of the present invention, the subscriber may provide instructions for allowing or blocking calls as a function of serving areas and/or as a function of specific digits.

In more detail, the call screening instructions relating to serving area provisioning permits the subscriber to select geographic or other identifiable groups as serving areas. The serving areas define logical entities, such as countries, towns, genres, and other definable subjects for call screening without requiring the subscriber to know or provide the telephone digits associated with such entities. In this manner, the serving areas may comprise whole countries and/or areas with in the countries, such as states, counties, cities, towns, etc., or groups, such a banks, business, or other commonly characterized entities within a country or number of countries.

The provisioning of serving areas generally relates to receiving non-digit specific inputs from the subscriber and associating digits with those inputs. This associating may require the telephone carrier to convert the non-digit specific inputs to digit specific values in order to permit the screening of the international call. In accordance with one non-limiting aspect of the present invention, the serving areas may be associated with a collection of country codes, country codes and city codes, and/or complete phone numbers. Such associating may be completed by the telephone carrier as opposed to the subscribers so as to facilitate ease of use and customer satisfaction.

In more detail, the associations may be completed through an application which cross-references the non-digit specific input with a look-up table of numbers, such as to associate country names with country codes, city names with country codes plus city codes, business names with country codes plus city codes plus specific phone numbers, and the like. In this manner, the subscriber simply provides the generalized description and the telephone carrier determines the digits associated therewith.

For example, the telephone carrier may provide a graphical user interference (GUI) (not shown) on a webpage or other subscriber accessible medium to facilitate subscriber selection of the serving areas. The GUI may include drop-down menus, geographical maps, and other features associated with selecting geographical areas or other group identifying specifications. Based on the inputs thereto, the telephone carrier may consult tables, memories, logic, or other features to automatically associate digits with the inputted information.

The subscriber may select any number of serving areas or groups of serving areas. The selections may be stored in a ‘My Selections’ folder or other account associated with the subscriber. The subscriber may access their account to update, add, change, or perform other operations with respect to the serving area. The subscriber account may be accessible through the GUI and include features for displaying the selected serving areas, such as through maps, tables, or other easily identifiable representations, which preferably list the serving area as opposed to the telephone digits associated therewith.

The telephone carrier, as described below in more detail, screens telephone calls associated with the subscriber as a function of the serving areas. More particularly, the telephone carrier associates the serving areas with telephone digits and screens the international calls as a function thereof. For example, if the serving area relates to a country, then international calls having country codes associated with the specified country are screened. Likewise, if the serving area relates to a cities or towns within a country, then international calls having country codes plus city codes associated with the specified cities or towns are screened, thereby providing more granularity than simply screening country codes. Still further, greater granularity may be provided if the serving area is associated with specific representations or other identifiable groups within one or more countries, such as banks, stores, business, etc., wherein complete phone numbers are associated with each member of the group such that international calls having country codes plus city codes plus specific numbers (the combination of which produces complete numbers) associated with each member of the group are screened.

Advantageously, the provisioning of the call screening instructions in this manner provides a subscriber friendly approach to call screening as it permits subscribers to simply specify areas, groups of areas, groups of business, or other non-digit specific references for call screening. The association of these serving areas with the telephone digits actually required to perform the call screening is alleviated from the subscriber and performed by the telephone carrier, or other software, logic, or feature associated therewith.

The provisioning of call screening instructions may also include digit specific provisioning, i.e., in addition to the foregoing non-digit specific call screening instructions (serving areas). The digit specific provisioning allows the subscribers to specify lists of country codes, country codes plus city codes, and complete numbers for call screening. In this manner, subscribers, who may not know countries, towns, or other non-digit information associated with telephone numbers desired for screening may input digits through the GUI or other interface.

The digit specific call screening instructions provide granularity similar to that described above as it allows subscriber to screen calls at varying levels of specificity, i.e. at broad country code levels or narrow complete number levels. Likewise, a ‘My Selections’ folder or other account information may keep track of the inputted digits for the subscribers. Advantageously from a carrier perspective, the ability of subscribers to input digits for screening helps ameliorate processing demands, oversight, and other features associated with converting the non-digit specific inputs of the serving areas to digits suitable for screening.

In accordance with one non-limiting aspect of the present invention, the call screening instructions may include any number of features for controlling call screening, such as one or more of an international origination serving area routing (IOSAR) feature, international destination serving area routing (IDSAR) feature, international originating dependent routing (IODR) feature, or international destination dependent routing (IDDR) feature.

If the call screening instructions relate to the IOSAR feature, the routing of the international call is either allowed or blocked as a function of the provisioned serving area call screening instructions associated with the subscriber (or VPN) making the international call. In particular, the IOSAR feature allows or blocks the international call as a function of whether a collection of country codes, country codes plus city codes, or complete numbers associated with the serving area call screening instructions of the subscriber making the international call match a calling party ID associated with the international call.

In operation, the digits associated with the serving areas for the subscriber are compared to the calling party ID of the entity originating the international call. The calling party ID typically corresponds with the telephone number assigned to the telephone from which the call is originating. If the originating telephone number matches with one of the numbers specified by the serving areas, the associated telephone call is either allowed or blocked.

Of course, however, the present invention is not intended to be limited to calling party IDs which are only associated with the telephone making the international call. Rather, the present invention contemplates any number of other applications, such as applications relating to virtual private networks (VPN). In more detail, a VPN may have assigned calling party IDs, such as personal identification numbers (PINs), usernames, IP address, or other identifiers associated with users of the VPN and not necessarily the telephone originating the call. In such environments, the calling ID may correspond with an indicator other than the telephone making the international call.

With respect to VPNs, the present invention contemplates any number of other specifications and user variables. In particular, the VPN may include a system manager or other individual associated with inputting the call screening instructions and controlling selection of the serving areas and digit specific values for one or more users of the VPN, which is common in businesses with multiple employees where an office manager may control international calling features. In some cases, a user may be required to login into the VPN to dial international calls, such as by entering a user ID and password, whereby the call screening of the present invention may be correspondingly limited to users once they have logged into the VPN.

If the call screening instructions relate to the IDSAR feature, the routing of the international call is either allowed or blocked as a function of the provisioned serving area call screening instructions associated with the subscriber (or VPN) making the international call. In particular, the IDSAR feature allows or blocks the international call as a function of whether a collection of country codes, country codes plus city codes, or complete numbers associated with the serving area call screening instructions match a called party ID associated with the international call.

In operation, the digits associated with the serving areas are compared to the called party ID of the entity to which the international call is destined. The called party ID typically corresponds with the telephone number assigned to the telephone to which the call is destined. If the destination telephone number matches with one of the numbers specified by the serving areas, the associated telephone call is either allowed or blocked. Of course, as described above, other features besides the destination telephone number may be associated with the called party ID, such as PINs, usernames, or other destination identify elements.

If the call screening instructions relate to the IODR feature, the routing of the international call is either allowed or blocked as a function of the provisioned digit based call screening instructions associated with the subscriber (or VPN) making the international call. In particular, the IODR feature allows or blocks the international call as a function of whether a listing of country codes, country codes plus city codes, or complete numbers associated with the digit specific call screening instructions match a calling party ID associated with the international call.

If the call screening instructions relate to the IDDR feature, the routing of the international call is either allowed or blocked as a function of the provisioned digit based call screening instructions associated with the subscriber (or VPN) making the international call. In particular, the IDDR feature allows or blocks the international call as a function of whether a listing of country codes, country codes plus city codes, or complete numbers associated with the digit specific call screening instructions match a called party ID associated with the international call.

As described above, the call screening instructions of the subscriber making the international call may include any number of features for allowing or blocking the international call. In accordance with one non-limiting aspect of the present invention, these features generally include allowing or blocking the call as a function of serving area specific call screening instructions or digit specific call screening instructions.

The present invention, however, is not intended to be limited to only these features. Rather, the present invention contemplates other features, including call screening based two or more of the foregoing features. For example, the subscriber (or VPN) may desire to perform both IOSAR and IDSAR features so as to screen calls based on the originating party (calling party ID) and destination party (called party ID), which may be advantageous in company VPNs to insure only authorized users are making international calls and that such calls are being made to authorized destinations. Of course, the present invention contemplates any number of combinations ,of the these and other features.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of screening international calls, the method comprising:
receiving call screening instructions from a subscriber;
receiving an international call;
determining whether the international call is associated with the subscriber;
if the international call is associated with the subscriber, determining a screening feature for the international call as a function of the call screening instructions; and
routing the international call as a function of the screening feature.

2. The method of claim 1 further comprising:
determining the screening feature to be at least one of an international origination serving area routing (IOSAR) feature, international destination serving area routing (IDSAR) feature, international originating dependent routing (IODR) feature, or international destination dependent routing (IDDR) feature.

3. The method of claim 2 further comprising:
determining multiple screening features for the international call as a function of the entrance criteria and routing the international call as a function of the multiple screening features.

4. The method of claim 1 further comprising:
receiving serving area call screening instructions which specify one or more geographical areas and screening the international call as a function of the geographical areas.

5. The method of claim 4 further comprising:
receiving serving area call screening instructions having an international origination serving area routing (IOSAR) feature wherein the routing of the international call is either allowed or blocked as a function of whether a collection of country codes, country codes plus city codes, or complete numbers associated with the serving area call screening instructions match a calling party ID associated with the international call.

6. The method of claim 4 further comprising:
receiving serving area call screening instructions having an international destination serving area routing (IDSAR) feature wherein the routing of the international call is either allowed or blocked as a function of whether a collection of country codes, country codes plus city codes, or complete numbers associated with the serving area call screening instructions match a called party ID associated with the international call.

7. The method of claim 1 further comprising:
receiving digit specific call screening instructions which lists one or more phone numbers and screening the international call as a function of the phone numbers.

8. The method of claim 7 further comprising:
receiving digit specific call screening instructions having an international origination dependent routing (IODR) feature wherein the routing of the international call is either allowed or blocked as a function of whether a collection of country codes, country codes plus city codes, or complete numbers associated with the digit specific call screening instructions match a calling party ID associated with the international call.

9. The method of claim 7 further comprising:
receiving digit specific call screening instructions having an international destination dependent routing (IDDR) feature wherein the routing of the international call is either allowed or blocked as a function of whether a collection of country codes, country codes plus city codes, or complete numbers associated with the digit specific call screening instructions match a called party ID associated with the international call.

10. The method of claim 1 further comprising:
determining access to a virtual private network (VPN) as a function of the entrance criteria and routing the international call only if access to the VPN is determined.

11. The method of claim 1 further comprising:
providing a remotely accessible graphical user interface for receiving the call screening instructions from the subscriber.

12. The method of claim 11 further comprising:
configuring the GUI to include drop down menus for selecting geographical areas and input fields for inputting digits associated with phone numbers.

13. A system of screening international calls, the system comprising:
a service contact point (SCP) configured to apply at least one of a number of granular call screening features to international calls so as to screen the international calls according to subscriber specified call screening instructions.

14. The system of claim 13 further comprising: a graphical user interface for inputting the subscriber call screening instructions to the SCP.

15. The system of claim 13 wherein the screening features include at least one of an international origination serving area routing (IOSAR) feature, international destination serving area routing (IDSAR) feature, international originating dependent routing (IODR) feature, or international destination dependent routing (IDDR) feature.

16. The system of claim 13 wherein the SCP is configured to receive queries from call routing features upon receipt of international calling requests and response thereto with instructions as to whether the requested call should be blocked or allowed, the calls being blocked or allowed as a function of the SCP call screening features.

17. The system of claim 13 wherein the SCP is configured to receive non-digit specific call screening instructions and to associate the non-digit specific instructions with digit specific instructions to facilitate screening of the international telephone call.

18. The system of claim 17 further comprising
a database of telephone numbers associated with non-digit specific identifiers for use in associating the non-digit specific call screening instructions with digit specific call screening instructions.

19. A method of call screening, the method comprising:
determining digit specific call screening instructions as a function of non-digit specific call screening instructions specified by the subscriber;
determining at least one call screening feature as a function of the non-digit specific call screening instructions specified by the subscriber; and
screening the telephone call as a function of the digit specific call screening instructions and the call screening features.

20. The method of claim 19 further comprising
determining the call screening feature to include at least one of an international origination serving area routing (IOSAR) feature, international destination serving area routing (IDSAR) feature, international originating dependent routing (IODR) feature, or international destination dependent routing (IDDR) feature.
